(19) United States
(12) Patent Application Publication
(10) Pub. No.: US 2012/0271654 A1
(43) Pub. Date: Oct. 25, 2012

(54) Method and System for Wound Care and Management Output

(75) Inventors: John E. Croghan, Wilmette, IL (US); Philip H. Sheridan, JR., Winnetka, IL (US)

(73) Assignee: TELEMEDICINE SOLUTIONS LLC, Wilmette, IL (US)

(21) Appl. No.: 13/443,036

(22) Filed: Apr. 10, 2012

Related U.S. Application Data
(63) Continuation-in-part of application No. 11/336,036, filed on Jan. 20, 2006.

(51) Int. Cl. G06Q 50/24

(52) U.S. Cl. 705/3

(57) ABSTRACT

A method and system for use by professionals in the healthcare industry, for the management and care of wounds such as bedsores, pressure ulcers, and the like. The method and system comprises an application residing on a handheld wireless device with an integrated camera, to record clinical data at point-of-care regarding both the patient and the wound. The data gathered by this application/device at the patients' bedside will be uploaded to and outputted via the Internet from a master database where additional tracking and analysis can be done by personnel leading to additional, improved and customized preventive interventions and treatment options. Clinical treatment algorithms may be used to help guide accurate assessment and treatment of the wounds.

This is a continuation-in-part of patent application Ser. No. 11/336,036 entitled Method and System for Wound Care and Management filed on Jan. 20, 2006.

### BACKGROUND OF THE INVENTION

1. Field of the Invention

The present disclosure relates generally to methods and systems for wound care documentation and care management, and in particular, to methods and systems for transmitting and retrieving medical data and pictures captured with a camera-enabled wireless communication device for the purpose of managing wounds such as pressure ulcers in patients such as the elderly. Specifically, the present disclosure relates to methods and systems interacting with a customized, camera-enabled wireless communication device and an Internet accessible master data base, and utilizing a risk assessment tool used to predict a patient's level of risk for developing a pressure ulcer, for the prevention, management and treatment of wounds in elderly patients.

2. Description of the Prior Art

Pressure ulcers, or wounds, also known as pressure sores, decubitus ulcers, bed sores, and ischemic ulcers, are painful skin lesions caused by unrelieved compression resulting in damage to underlying tissue. Such localized areas of soft tissue injury are a great source of suffering for elderly patients. The term ‘pressure ulcer’ is most appropriate when it denotes the principle etiologic factor of unrelieved pressure on or contact with the skin over a bony prominence resulting from external factors, such as shearing (an object, e.g. a bed sheet, moving across the skin) or friction (an object, e.g. a bed sheet and the skin both moving against each other). The most common sites (80%) for ulcer development are the pelvic girdle (ischiums, coccyx and trochanters) and the heels, especially in patients with co-morbid diabetes.

Pressure ulcers are a common and serious morbidity and mortality issue in geriatric medicine, affecting up to 24% of the 1.6 million U.S. nursing home residents each year. Patients admitted to nursing homes with a pressure ulcer have a 50% one-year mortality rate compared to a 27% one year mortality rate for patients admitted without ulcers. The most common morbidity associated with such wounds is infection, and the mortality rate increases six-fold for elderly patients whose wounds do not heal. Complications that are more likely to arise when a patient is suffering from a pressure ulcer include local infection (including soft tissue abscesses and cellulitis) osteomyelitis, bactermia, marjoran's ulcer and death.

Pressure ulcers are one of the most expensive conditions to treat in the elderly, with current costs to heal ranging from approximately $2,000 to $40,000 per wound. Wound care in nursing homes has traditionally been difficult to manage and is often a source of state and federal inspection violations. Wound care ranks second, to wrongful death, for lawsuits against long-term care providers.

It is estimated that over one million patients develop wounds each year, with approximately 70% of the new cases occurring in patients over 70 years of age. These general figures are accepted in the geriatric field although there are no widely accepted methods for collecting or reporting this incidence of pressure ulcers. Many details must accompany incidence reporting such as, hospitalization status and length, post-surgical status and bed bound status. Some, but not all, common methods for quantifying incidence include percent development over time; number of sores per 1000 patient days; and number of sores per institution.

For example, some reported incidence rates are as follows. The incidence rate of pressure ulcers among hospitalized patients may be as high as 8-25% over three weeks in bed or chair-bound patients. The incidence rate of pressure ulcers may be as high as 22-29% per 1000 patient days in adult-ICU patients. The one-year incidence rate is 13% for nursing home patients.

Prevention of wound development is an essential, albeit labor-intensive, component to providing quality healthcare for the elderly. Thorough skin assessments and screening for known risk factors need to be conducted systematically for each resident upon admission to a nursing home facility and on a regular basis throughout the resident's stay. If prevention is not successful and a wound develops, the new, active wound constantly changes. Only through ongoing, thorough assessment of an active wound can an appropriate, dynamic treatment be realized.

Known risk factors for wound development include both internal and external risk factors. The common internal risk factors (in alphabetical order) for pressure ulcer development in the elderly include: Age; Co-morbidities; Depression; History of pressure ulcers; Immobility; Incontinence; Malnutrition; Medications, such as steroids; Refusal of care; Sensory Deficiencies; and Thin Body Habitus. The common external risk factors (in alphabetical order) for pressure ulcer development in the elderly include: Friction; Moisture; Pressure; and Shearing.

A validated risk assessment tool, such as the Braden Scale, can be used to predict a patient's level of risk for developing a pressure ulcer. The Braden Scale is a copyrighted tool that collects and scores the following risk factors:

Sensory Perception: ability to respond meaningfully to pressure-related discomfort (scale 1-4):

1. Completely limited; 2. Very limited; 3. Slightly limited; 4. No impairment.

1. Moisture: degree to which skin is exposed to moisture (scale 1-4):

1. Constantly moist; 2. Very moist; 3. Occasionally moist; 4. Rarely moist.

1. Activity: degree of physical activity (scale 1-4):

1. Bedfast; 2. Chairfast; 3. Walks occasionally; 4. Walks frequently.

1. Mobility: ability to change and control body position (scale 1-4):

1. Completely immobile; 2. Very limited; 3. Slightly limited; 4. No limitation.

1. Nutrition: usual food intake pattern (scale 1-4):

1. Very poor; 2. Probably inadequate; 3. Adequate; 4. Excellent.

1. Friction and Shear (scale 1-4):

1. Problem; 2. Potential problem; 3. No apparent problem.

In an effort to prevent pressure ulcers, prevention protocols are enacted that include targeted, organized interventions for reducing such risk factors. Specific preventive measures include: Maintain personal hygiene; Assure adequate nutrition; Manage urinary/fecal incontinence; Reposition and have patient shift weight; Avoid massaging reddened areas; Prevent contractures; Position to alleviate pressure over bony prominences (including pressure reducing mattresses and other pressure relieving devices); Use positioning devices/foam; Maintain lowest head elevation; and Use lifting devices.

In situations where prevention of a wound is not successful, proper management of the wound is essential for effective treatment and cure. This management includes recognition, assessment, treatment and monitoring of the wound.

The ‘recognition’ of pressure ulcers includes identification of: 1) risk factors for the development of pressure ulcers (see above for risk factors); 2) the ulcer types (vascular insufficiency/ischemia, neuropathic, pressure); and 3) co-morbid conditions that may affect the healing of developed ulcers (malnutrition and dehydration, diabetes mellitus, end-stage renal disease, thyroid disease, congestive heart failure, peripheral vascular disease, vasculitis, immune deficiency states, malignancies, COPD, Depression and psychosis, Drugs that affect healing, Contractures at major joints).

The ‘assessment’ of pressure ulcers includes identification of a stage of the wound from the stages defined by the National Pressure Ulcer Advisory Panel (NPUAP) and recommended in the Centers for Medicare & Medicaid (CMS) Resident Assessment Instrument (RAI) manual (v 2.0), which stage pressure ulcers according to the degree of tissue damaged, as follows:

Stage I: Nonblanchable erythema of intact skin; the heralding lesion of skin ulceration. In individuals with darker skin, discoloration of the skin, warmth, edema, induration or hardness.

Stage II: Partial-thickness skin loss involving epidermis or dermis, or both. The ulcer is superficial and presents clinically as an abrasion, blister or shallow crater.

Stage III: Full-thickness skin loss involving damage or necrosis of subcutaneous tissue, which may extend down to but not through underlying fascia. The ulcer presents clinically as a deep crater with or without undermining of adjacent tissue.

Stage IV: Full-thickness skin loss with extensive destruction, tissue necrosis, or damage to muscle, bone or supporting structures (such as tendon and joint capsule). Undermining and sinus tracts also may be associated with Stage IV.

The ‘treatment’ of pressure ulcers includes following wound care guidelines based on wound stage. Although wound care needs to be specialized to each patient, general treatment plans can be described, including the use of wound care products including hydrocolloids, alginates, foams, wound fillers, composite dressings.

For ongoing wound care for a wound responding to treatment, the following steps are generally performed: 1) Cleanse wound at each dressing change; 2) Debride eschar, as needed; 3) Evaluate/treat for infection; 4) Employ facility infection control; 5) Re-evaluate co-existing medical conditions; 6) Prescribe pain control measures; and 7) Address psycho-social issues, depression and possible isolation.

For wound care for a non-responding wound, the following steps are generally performed: 1) Apply topical antibiotic for two weeks; 2) Progress to support surface that offers protection; 3) Consider a course of electrotherapy; and 4) Consider transfer to another site.

The ‘monitoring’ of pressure ulcers includes monitoring the status of a healing wound, which requires, at a minimum, regular assessments of the success of the treatment regimen. This status review should include documentation of the patient response to treatment. Any adjustments to treatment and development of any complications should also be documented. Treatment adjustments may include changing dressing types, debridement options, nutritional programs, and support surface options.

Accordingly, the goals of a system to prevent and manage pressure ulcers are:

1. Wound improvement/healing;

2. Prevent additional skin breakdown;

3. Prevent decline in overall condition; and

4. Pain reduction.

Traditional methods and/or systems for wound care generally include manual documentation of the history of the patient, the assessment of the skin and the wound, and the assessment of pressure ulcer risk by the care givers. Data gathered are for the most part localized to the particular treatment facility. The lack of standardized processes for wound assessment and documentation inhibits communication and coordination of care. Thus, prevention and management of wounds are usually limited by the experience of the care givers at the particular facility or site of care. Further, errors in documentation of patient or wound information, or in the management and treatment of the wounds, can result in a failure to reach the above stated goals of the system.

Several “computerized” methods and systems relating to the healthcare industry in general are known, for example, as disclosed in the following patents and Published applications: U.S. Pat. No. 6,792,137; U.S. Pat. No. 5,967,979; U.S. Pat. No. 5,842,976; U.S. Pat. No. 5,836,877; U.S. Pat. No. 5,836,872; U.S. Pat. No. 5,588,428; JP08149216; US2005/0149360; US2005/0135662; US2005/0119539; US2005/0084176; US2005/0027567; US2004/0220464; US2004/0136579; US2003/0069759. The disclosures of each of these references are herein incorporated by reference. These known methods and systems, however, fail to address and/or are inadequate for the comprehensive prevention, management and treatment of wounds.

Accordingly, there is a need in the healthcare industry for an improved method and system for wound care documentation and care management which will, inter alia, enable nurses to improve wound healing, prevent additional skin breakdown, prevent decline in overall condition and reduce pain; which is specialized to each patient; which is fast and easy to use and to record information; which provides fast and easy access to past and present patient and wound information, and which allows expert review. The method and system disclosed herein fulfills such a need, and provides numerous other benefits and advantages with respect to methods and systems for wound care and management.

### SUMMARY OF THE INVENTION

The present disclosure relates generally to a method and system utilizing the transmission, entry and retrieval of data and pictures (images) captured with a camera-enabled wireless communication device such as an all-in-one Personal Digital Assistant (PDA) or smart phone, for the purpose of managing wounds in elderly patients. Data about the patient and the wound and a picture(s) of the wound are entered into a camera-enabled wireless communication device at the patient's bedside in a nursing home, hospital, home care setting or other setting. Using data entered at the bedside and logic programmed into the device by the proprietary software, a Braden Scale assessment of pressure ulcer risk is calculated. The data and the images are transferred, preferably wirelessly such as via cellular or WiFi, to a remote server where data and images are stored. Medical teams managing the patient can retrieve and review the patient and wound data and images from the remote server in useful formats via the Internet. Preventive interventions and/or treatment recommendations by these medical teams, beyond a Braden Scale assessment, can be entered. Preventive interventions and/or treatment recommendations stored on the server's data base can be sent via the Internet and downloaded to the camera-enabled wireless communication device during synchronization. Updates to the status of the wound and the prevention and/or treatment plans are sent back and forth between the wireless communication device and the remote server with each assessment until the patient's wound is healed or the patient is discharged. The remote server is the central repository for all patient and wound data and wound pictures. Patient-specific and aggregate data is available to authorized care team members.

It is another object of the present disclosure to provide a method and system for collecting and storing data, including a Braden Scale Assessment, about the patient and the wound using the camera-enabled wireless communication device, providing a Braden assessment data point of each sub-category: sensory perception, moisture, activity, mobility, nutrition and friction/shear.

It is another object of the present disclosure to provide a method and system for collecting and storing data, including a Braden Scale Risk Assessment, about the patient and the wound using the camera-enabled wireless communication device and remote server, for calculating a Braden Score.

It is another object of the present disclosure to provide a method and system for collecting and storing data, including a Braden Scale Assessment, about the patient and the wound using the camera-enabled wireless communication device and remote server, for generating preventive interventions and/or treatment recommendations and/or protocols based on at least the calculated Braden Score and sub-scores.

It is another object of the present disclosure to provide a method and system for collecting and storing data about a patient and the patient's wounds and photos of the patient's wounds using a camera-enabled wireless communication device and a remote server for data storage with an application designed to receive, compile, store and display data about the patient and the wound and picture(s) of the wound from captured by the camera-enabled wireless communication device or PC-based keyed entry.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, and providing notice that the transmitted data and pictures were received by the server.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the data- and photo-enabled wireless communication device or PC-based keyed entry, wherein a physician or other healthcare professional connected to the patient can access the server via the Internet.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein a physician or other healthcare professional connected to the patient can access patient-specific record summaries.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the data- and photo-enabled wireless communication device or PC-based keyed entry, wherein a physician or other healthcare professional connected to the patient can access patient-specific record information, including date of last update, changes in Braden score and granular historic data.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein a physician or other healthcare professional connected to the patient can access preventive interventions and/or treatment recommendations.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein a physician or other healthcare professional connected to the patient can access past and current preventive interventions and/or treatments for consultation purposes.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein one or more wound care experts, not directly related to the patient, can access patient-specific record summaries.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein one or more wound care experts, not directly related to the patient, can access patient-specific record information, including date of last update, changes in Braden score and granular historic data.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein one or more wound care experts, not directly related to the patient, can access treatment recommendations.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein one or more wound care experts, not directly related to the patient, can access past and current treatments.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein a healthcare professional directly treating the patient accesses preventive interventions and/or treatment recommendations from the server using a PC, and wherein preventive interventions and/or treatment recommendations can be printed and placed in the patient's chart as part of the permanent medical record.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein the healthcare professional directly treating the patient can synchronize the data- and camera-enabled wireless communication device with the server via cellular or WiFi to receive preventive interventions and/or treatment recommendation approval and comments.

It is another object of the present disclosure to provide a method and system for collecting and storing data about a patient and the patient's wounds and photos of the patient's wounds using a camera-enabled wireless communication device, including a server for data storage with an application designed to receive, compile, store and display data about the patient and the wound and picture(s) of the wound from the camera-enabled wireless communication device or PC-based keyed entry, wherein aggregate patient and wound data and wound pictures will be able to be retrieved from the server.

Numerous other advantages and features of the disclosure will become readily apparent from the following detailed description, from the claims and from the accompanying drawings in which like numerals are employed to designate like parts throughout the same.

### BRIEF DESCRIPTION OF THE DRAWINGS

The method and system for wound care and management in accordance with this specification are further described with reference to the accompanying drawings in which:

FIG. 1 is a schematic diagram of a basic infrastructure of a preferred embodiment of the method and system of the present disclosure.

FIG. 2 is a schematic diagram of an overview of the data or information provided in a preferred embodiment of the method and system of the present disclosure.

FIG. 3 is a general flow chart of a preferred embodiment of the method and system of the present disclosure.

FIG. 4 is an alternate flow chart of a preferred embodiment of the method and system of the present disclosure.

FIG. 5 is an exemplary server side Login screen of a preferred embodiment of the method and system of the present disclosure.

FIG. 6 is an exemplary server side Facility Identification screen of a preferred embodiment of the method and system of the present disclosure.

FIG. 7 is an exemplary server side Admitted Patients screen of a preferred embodiment of the method and system of the present disclosure.

FIG. 8 is an exemplary server side Wound Round Patients screen of a preferred embodiment of the method and system of the present disclosure.

FIG. 9 is an exemplary server side Telemedicine Patients screen of a preferred embodiment of the method and system of the present disclosure.

FIG. 10 is an exemplary server side New Patient Admission screen of a preferred embodiment of the method and system of the present disclosure.

FIG. 11 is an exemplary server side Facility—View all Wounds screen of a preferred embodiment of the method and system of the present disclosure.

FIG. 12 is an exemplary server side Facility—View all Wounds screen of a preferred embodiment of the method and system of the present disclosure, with view of selected wound.

FIG. 13 is an exemplary server side Facility—View all Treatments screen of a preferred embodiment of the method and system of the present disclosure.

FIG. 14 is an exemplary server side Facility—View all Wound Origins screen of a preferred embodiment of the method and system of the present disclosure.

FIG. 15 is an exemplary server side Patient Information screen of a preferred embodiment of the method and system of the present disclosure.

FIG. 16 is an exemplary server side Patient Demographics screen of a preferred embodiment of the method and system of the present disclosure.

FIG. 17 is an exemplary server side Patient Braden Scale screen of a preferred embodiment of the method and system of the present disclosure.

FIG. 18 is an exemplary server side Patient Braden Scale Protocols screen of a preferred embodiment of the method and system of the present disclosure.

FIG. 19 is an exemplary server side Patient Identified Wounds screen of a preferred embodiment of the method and system of the present disclosure.

FIG. 20 is an exemplary server side Patient Identified Wounds Pictures screen of a preferred embodiment of the method and system of the present disclosure.

FIG. 21 is an exemplary server side Patient Past Wound Assessment screen of a preferred embodiment of the method and system of the present disclosure.

FIG. 22 is an exemplary server side Patient Identified Wounds Trends screen of a preferred embodiment of the method and system of the present disclosure.

FIG. 23 is an exemplary server side Patient Identified Wounds Treatments screen of a preferred embodiment of the method and system of the present disclosure.

FIG. 24 is an exemplary server side Patient Consult Telemedicine Authorization screen of a preferred embodiment of the method and system of the present disclosure.

FIG. 25 is an exemplary server side Patient Consult Telemedicine Record screen of a preferred embodiment of the method and system of the present disclosure.

FIG. 26 is an exemplary server side Physician's Patient Information screen of a preferred embodiment of the method and system of the present disclosure.

### DETAILED DESCRIPTION OF THE ILLUSTRATED EMBODIMENTS

The specification and drawings of application Ser. No. 11/336,036 are hereby incorporated by reference. While the invention is susceptible of embodiment in many different forms, there is shown in the drawings and will be described herein in detail one or more embodiments of the method and system of the present disclosure. It should be understood, however, that the present disclosure is to be considered an exemplification of the principles of the invention, and the embodiment(s) illustrated is/are not intended to limit the spirit and scope of the invention and/or the claims herein.

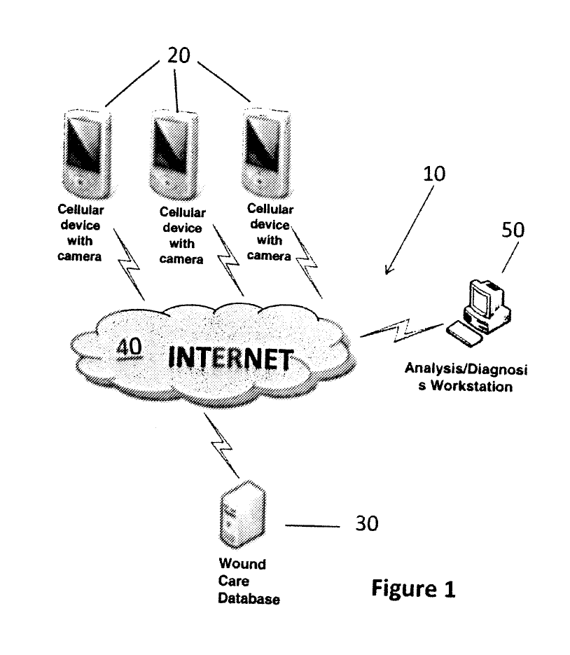

FIG. 1 is a schematic diagram of a basic infrastructure of a preferred embodiment of the method and system of the present disclosure. As can be seen, the basic hardware layout of the system 10 of the present disclosure comprises generally one or more wireless device(s) 20, for use at the location of the patient(s), and a remote database or server 30 in communication with the wireless device 20 via the internet 40 or any other suitable known communication medium. One or more analysis/diagnosis work station(s) 50 also communicate with the database 30 and/or the wireless device(s) 20. The work station(s) 50 may be directly connected to the database 30, or may be at a remote site and connected via the internet 40 or in another suitable manner. As should be understood by one of ordinary skill in the art, the system may be comprised of one or more processors, servers and databases, as well as suitable software for running the system.

Each wireless device 20 can be located in different medical facilities or within the same building if there are multiple areas where wounds need to be managed. Each remote work station 50 can be located in various locations as desired, for example in a medical facility where the nurses can track the status of their patients and input additional data not easily entered on the hand-held device 20; in a remote location where specialists can review cases and recommend treatment; and/or in the patient's doctor's office where their doctor can see and review their patient's care. Preferably, any computer system with internet access could be in communication with the server/database 30, with appropriate password protection and/or other known internet security measures.

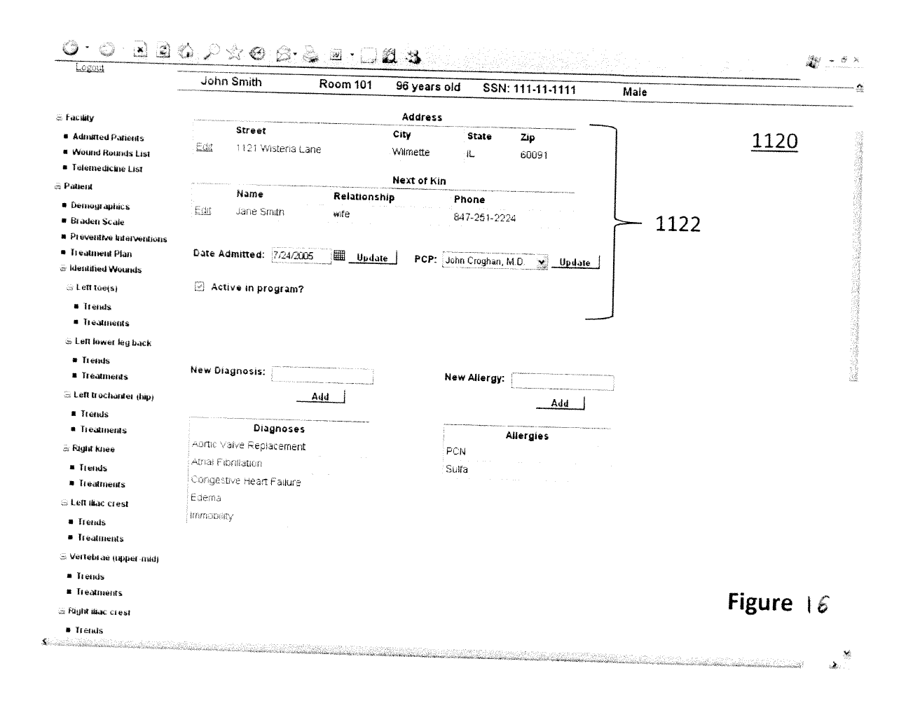

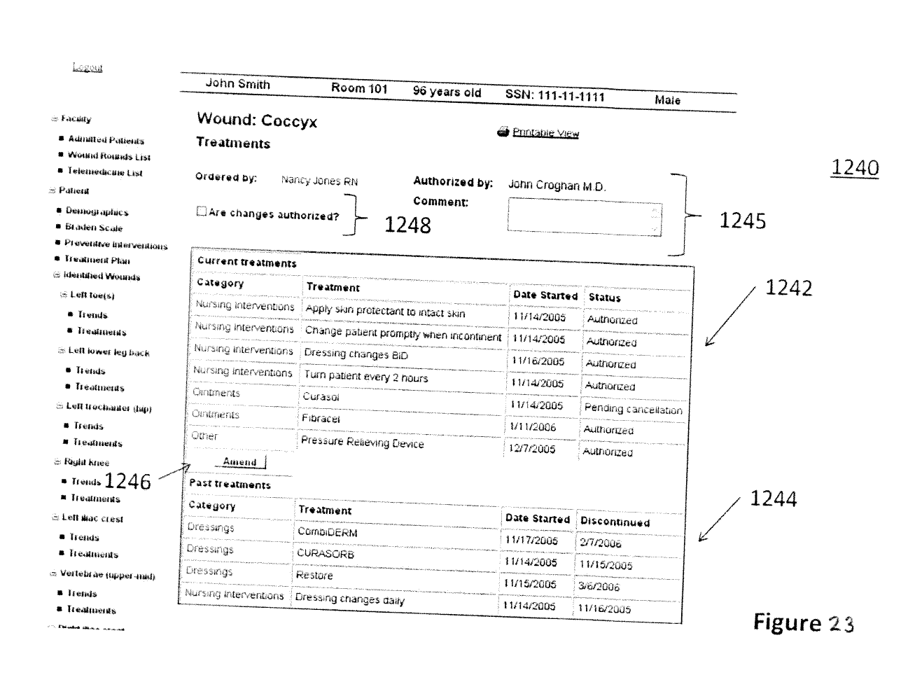

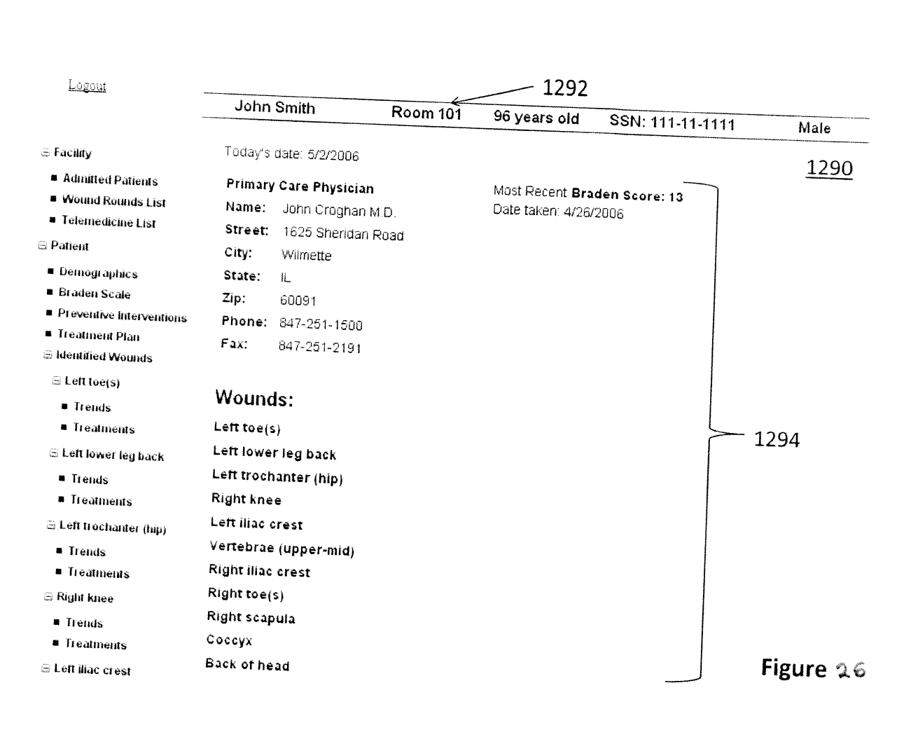

The wireless device(s) 20 preferably comprise a camera-enabled, wireless communication device or smart phone with a software application described in more detail with respect to FIGS. 1-26. However, it should be understood that the wireless device 20 could incorporate another imaging device, instead of or in addition to a camera, such as a video device, a hand held MRI device when available, a hand held CAT scan device, when available, and/or a hand held ultrasound device. It is also foreseen that the device 20 could include a non-contact wound measurement device, such as a laser based wound measurement device which determines the measurements of the wound automatically by scanning the wound using laser technology or other suitable technology.

Further, the device 20 need not be wireless, and could for example be any suitable PDA or desktop workstation, preferably portable, which can be connected to the internet, or otherwise transmit data. Any suitable laptop or notebook computer with internet access, preferably wireless, and allowing for connection of the imaging device(s) (e.g., a connection for a digital camera), could also be used and transformed by the proprietary software into a clinical wound documentation and care management system

In general, the software application is used to record clinical data at the bedside regarding both the nursing home resident or patient and the wound (if present), along with an image or images, e.g., digital photos of the wound. This information is preferably sent via cellular communication into a password-protected web server, i.e., database 30. The data and photos can then be reviewed via the Internet by one or more members of a physician-led health care team connected to the nursing home resident, and/or a team of wound experts not directly connected to the resident, via a workstation 50. The server and the smart phones or devices 20 utilize the software application to help guide accurate assessment and treatment of a patient's wound or wounds. The server's database 30 catalogs and monitors, over time, the clinical progress of the nursing home resident or patient and/or their wounds, and specifically documents the efforts involved in prevention and treatment.

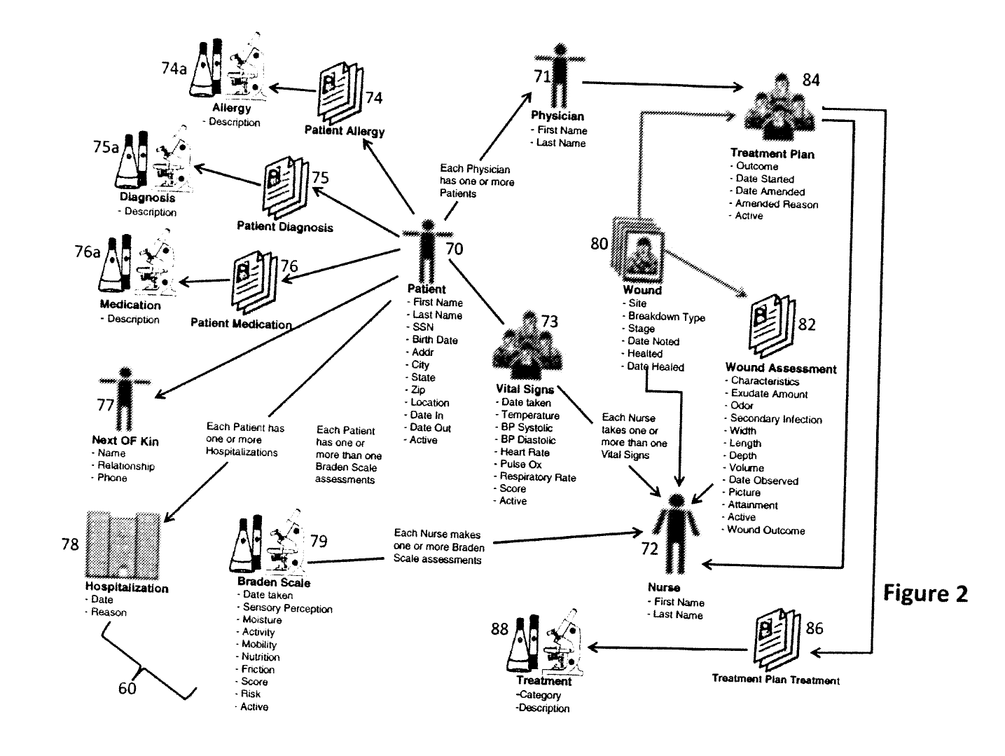

The database 30 will be a centralized repository of the data (see FIG. 2) stored in the method and system of the present disclosure, such as patient information 70 including, but not limited to, residence prior to nursing home admission (i.e., hospital, home, other nursing home), medical history, Braden scores, demographics, current medications, recent illness, and nutrition; and wound information 80 including but not limited to, length, width and depth measurements (cubic) of the wounds, as well as pictures to track size and color of the wounds. FIG. 2 provides a more comprehensive identification of the data 60 incorporated into the method and system of the present disclosure.

As can be seen in FIG. 2, the data 60 gathered, entered into and/or generated by the method and system of the present disclosure includes, but is not limited to, patient information 70 such as name, social security number, birth date, address, location (hospital, nursing home, etc.), date in, date out, etc. Additional information or data relating to the patient includes physician(s) name 71, nurse(s) name 72, and vital signs 73 such as temperature, blood pressure, heart rate, pulse ox., respiratory rate, date/time taken, etc. Further, data related to the patient's allergies 74 including allergy description 74a, the patient's diagnosis 75 including diagnosis description 75a, and the patient's medication 76 including medication description 76a are entered into the system. Next of kin data 77 and hospitalization data 78 are also entered if known.

The patient's Braden Score data 79, such as sensory perception, moisture, activity, mobility, nutrition, friction, score, risk, date taken, etc., is entered into the system. If the patient has an existing wound or wounds, wound data 80 such as site, breakdown type, stage, date noted, date healed, etc., is likewise entered into the system, as is wound assessment data 82 such as characteristics, exudates amount, odor, secondary infection, width, length, depth, volume, date observed, picture, attainment, wound outcome, etc. Using this Braden Score data 79, wound data 80 and wound assessment data 82, the method and system can be used to provide a treatment plan 84 including such information as outcome, date started, date amended, amended reason, etc. The treatment plan 84 includes a treatment plan treatment 86 and a treatment category/description 88.

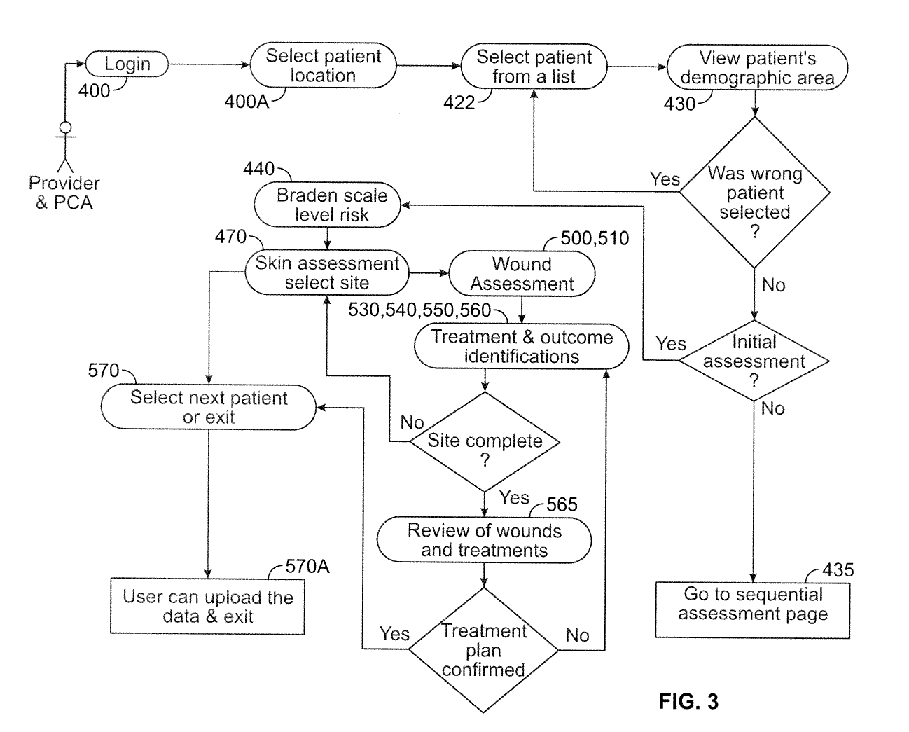

Referring now to FIG. 3, a general flow chart of a preferred embodiment of the method and system of the present disclosure is illustrated and provides a general overview of the method and system and the various paths that a user can take through the system. It should be understood that each step illustrated may encompass one or more of the corresponding screens, such as FIG. 3, and/or other screens described herein.

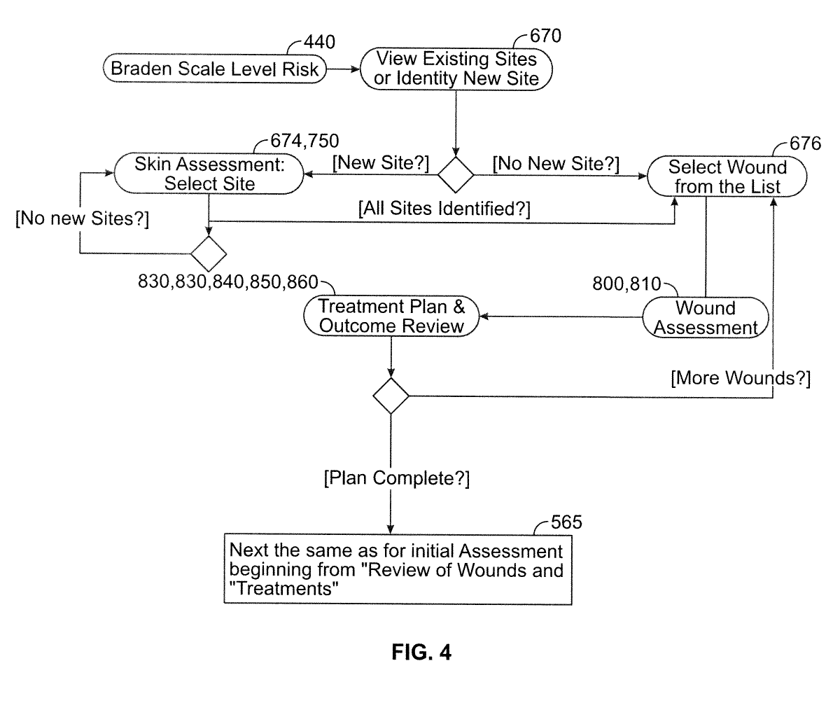

As illustrated, a healthcare provider using the PDA device 20 logs into the system, step 400, selects a patient's location, step 400a, and selects a patient from a list of patients, step 422. Next, the user views the patient's demographic data, step 430, and confirms that the right patient was selected. If the wrong patient was selected, the user returns to step 422. Once the right patient is selected, the nurse can either make an initial assessment and proceed to the patient's Braden Scale Level Risk, step 440, or go to the patient's sequential assessment page, step 435, for example as illustrated in FIG. 4.

For an initial assessment, the patient's Braden Scale Level Risk, step 440, is determined, and the user then selects a desired site for skin assessment, step 470. If the skin at the site is intact, the user can either select a next patient or exit the system, steps 570, 570a. If the skin is not intact and a wound is present at that site, the user makes a wound assessment for the selected site, step 500/510, and then makes or is provided with treatment and outcome identifications for the selected site, step 530. The user can then either return to step 470 to select a new site, or conduct a review of the wounds and treatments, step 565. From the review of the wounds and treatment, step 565, the user can amend the treatment plan by returning to step 530, or confirm the treatment plan. Once confirmed, the user can upload the data and exit the system, or return to the start and select a new patient, steps 570, 570a.

FIG. 4 illustrates the Sequential Assessment Page of step 435, essentially providing an alternate flow chart between the steps of determining the Braden Scale Level Risk, step 440, and reviewing of wounds and treatments, step 565, of FIG. 3, when a sequential assessment of a wound is being made. As illustrated in FIG. 4, from step 440, the user will view existing sites or identify new sites, step 670. If the user chooses to identify a new site, the user will proceed to the skin assessment—select site, step 674/750. This step can be repeated as desired. Once any new sites are identified, the user will select a wound from the list of wounds, step 676, proceed to wound assessment, step 800/810, and then to treatment plan and outcome review, step 830/840/850/860. Next, additional wounds can be selected by returning to step 676, or the user can proceed to step 565, Review of Wounds and Treatments. Thereafter, the remaining steps are as described with respect to FIG. 3.

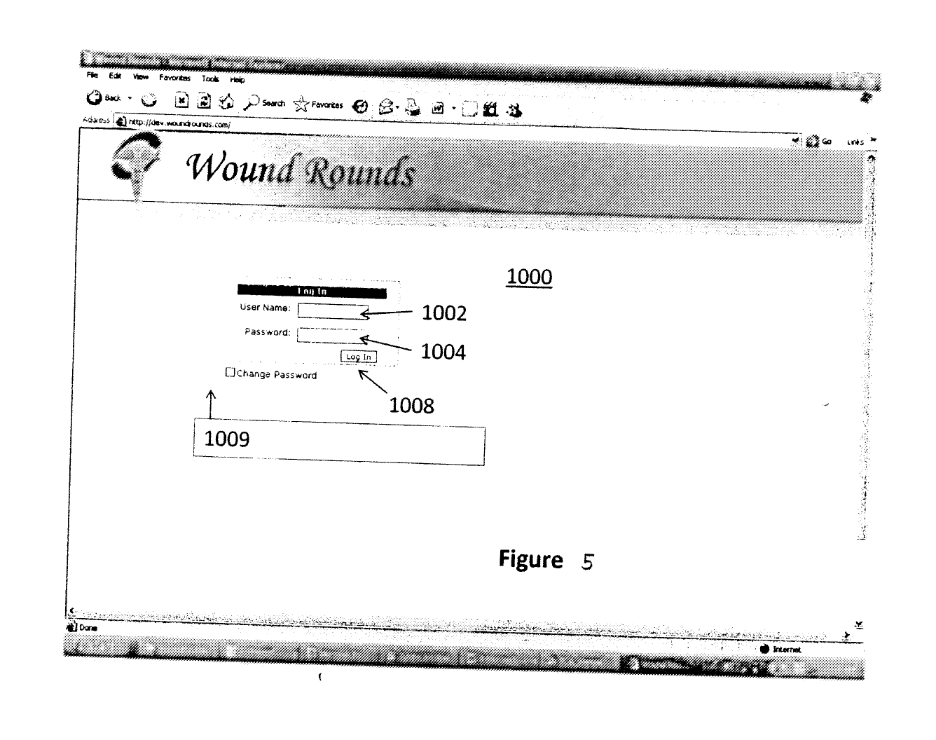

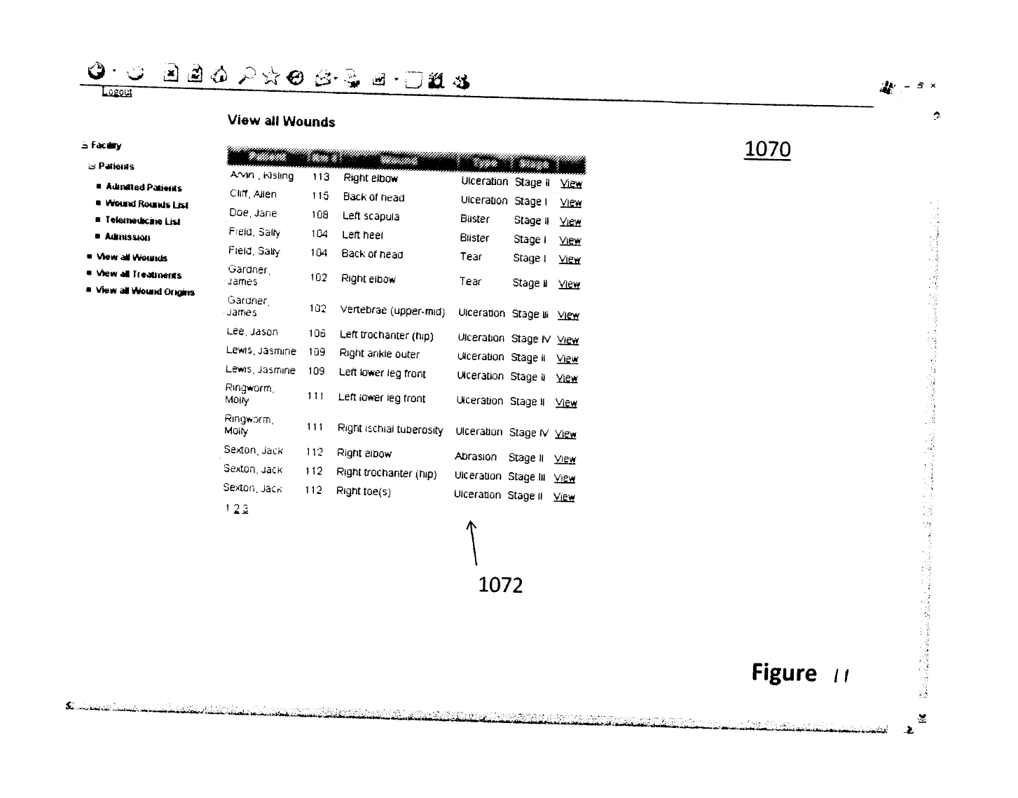

Referring now to FIGS. 5-26, the software application is described with respect to the various screen pages which a user may encounter as the user navigates through the disclosed method and system from the server side of the system, i.e., from a workstation connected to the server, or by any authorized user at a remote location with internet access to the server. While FIGS. 11-26 are illustrated with respect to a pressure ulcer, it should be understood that the disclosed method and system could be applicable for the treatment and management of any specific injury, disease, or medical condition. Additionally, the content of the screen pages illustrated in FIGS. 5-26 can be displayed in any suitable location or layout on the page, and the method and system of the present disclosure is not intended to be limited specifically to the layout(s) illustrated.

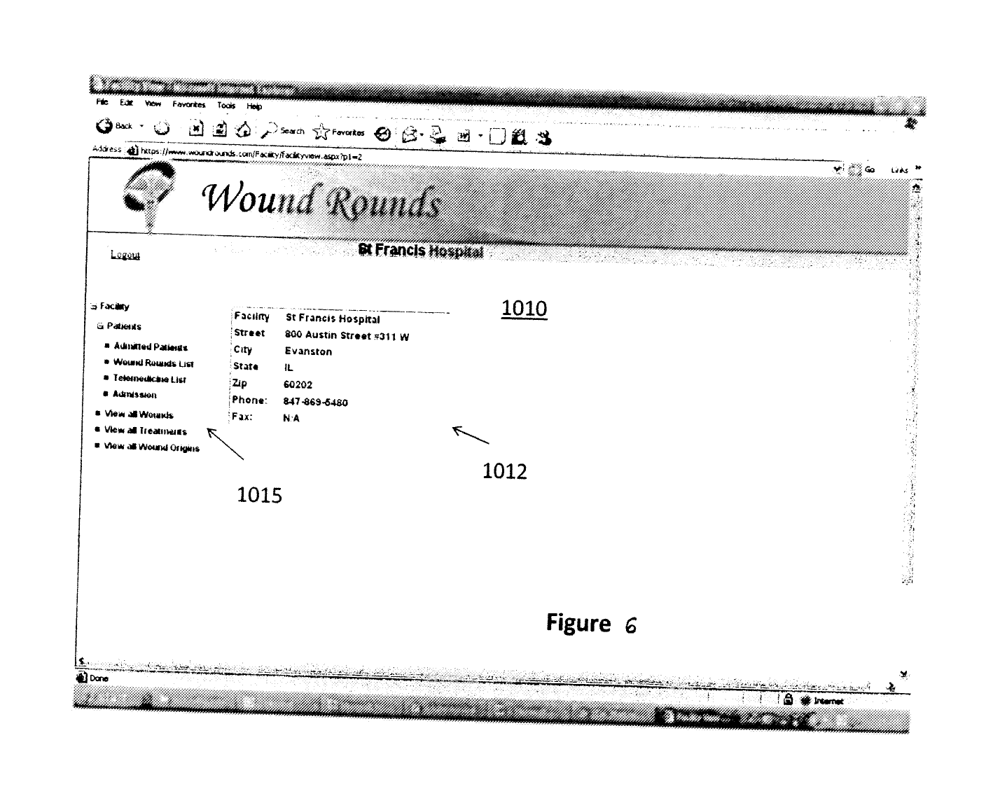

Screen 1010, FIG. 6, also includes a menu 1015 shown on the left hand side of the screen. In the menu 1015, under the facility heading, the user has the option of selecting the following menu items: Patients, View all Wounds, View all Treatments, and View all Wound Origins. Under the menu item Patients, the user has the option of selecting the following sub-headings: Admitted Patients, Wound Rounds List, consultant Telemedicine List, and Admission.

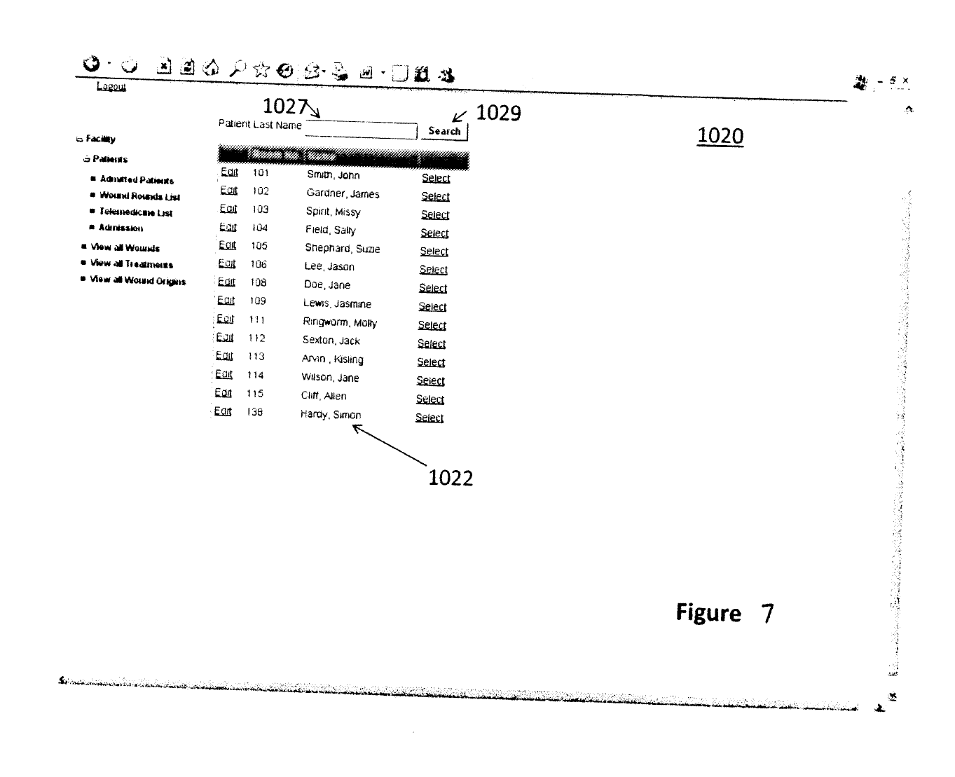

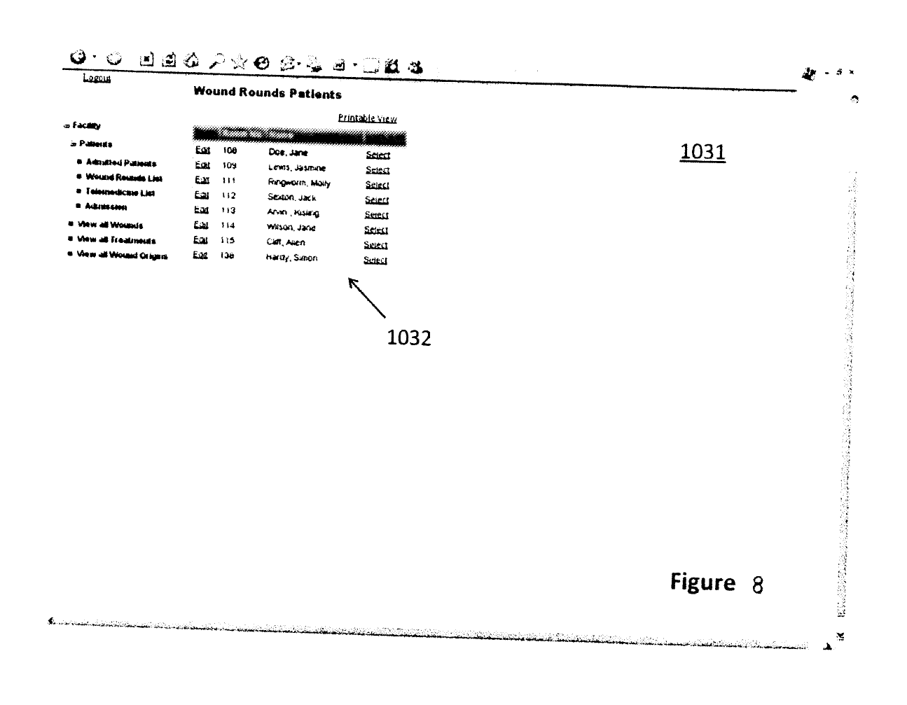

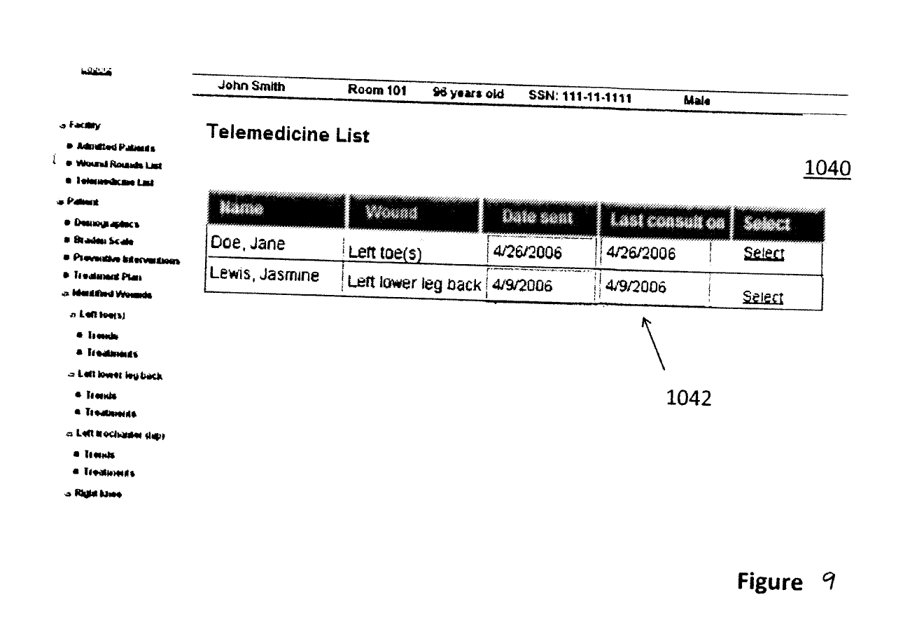

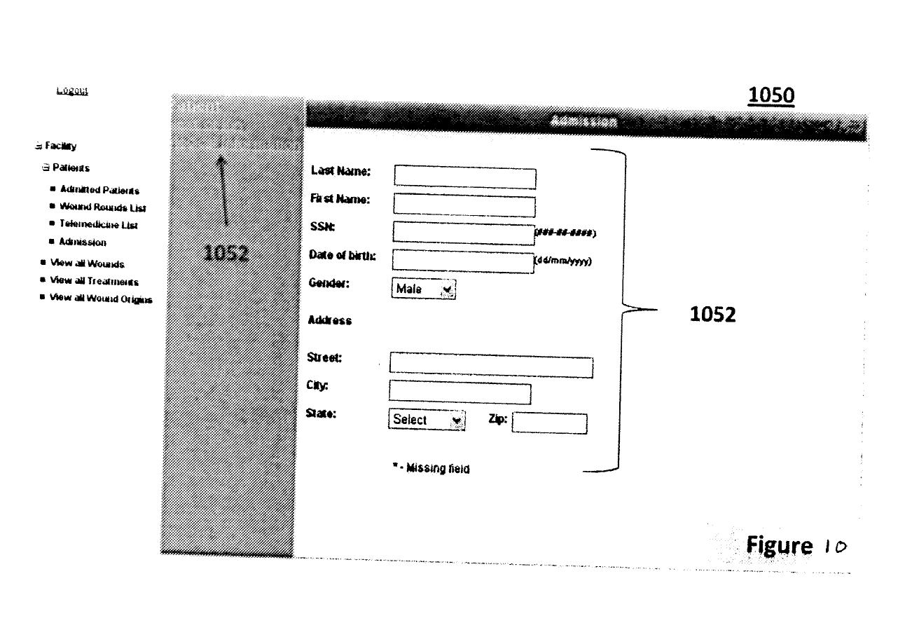

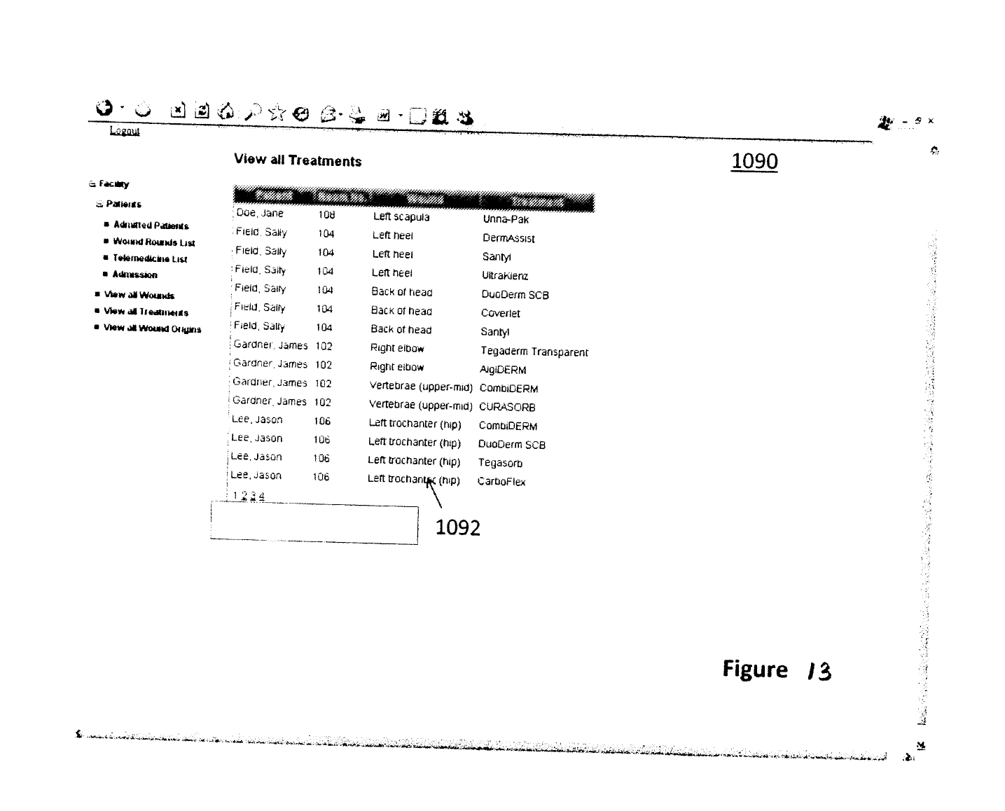

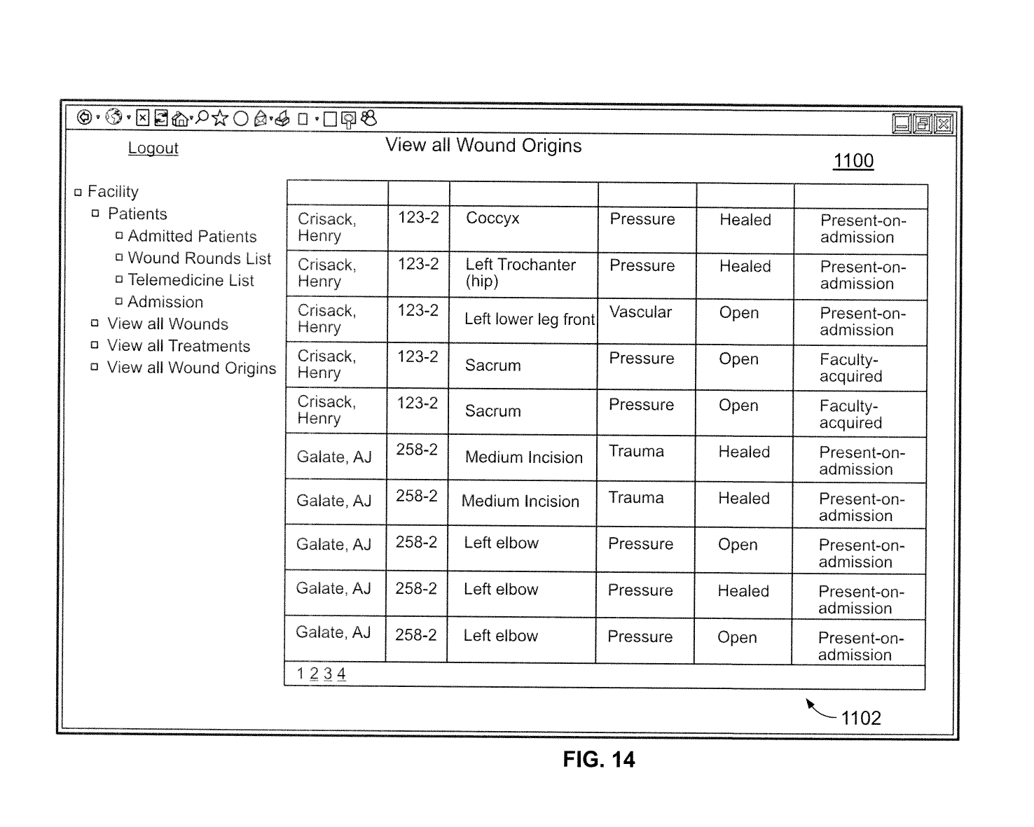

Selection of Admitted Patients from the menu 1015 brings the user to the Admitted Patients screen 1020 of FIG. 7. Selection of Wound Rounds List from the menu 1015 brings the user to the Wound Rounds Patients screen 1031 of FIG. 8. Selection of consultant Telemedicine List from the menu 1015 brings the user to the Telemedicine Patients screen 1040 of FIG. 9. Selection of Admission from the menu 1015 brings the user to the Admission—Patient Identification screen 1050 of FIG. 10. Selection of View all Wounds from the menu 1015 brings the user to the Facility—View all Wounds screen 1070 of FIG. 11. Selection of View all Treatments from the menu 1015 brings the user to the Facility—View all Treatments screen 1090 of FIG. 13. Selection of View all Wound Origins from the menu 1015 brings the user to the Facility—View all Wound Origins screen 1100 of FIG. 14.

Referring now to FIG. 11, the Facility—View all Wounds screen 1070 is illustrated. Screen 1070 displays a list of patients and their wounds in patient wound information display field 1072. Depending on the size of the list, the list could continue to a second page or additional pages, which can be accessed by selecting the page numbers at the bottom of the display field 1072, or alternatively via a scroll bar as desired. Patient wound information display field 1072 includes the patient's name, room number, wound location, wound type, and wound stage. A patient with multiple wounds will have multiple listings. A View hyperlink is provided to each wound listed.

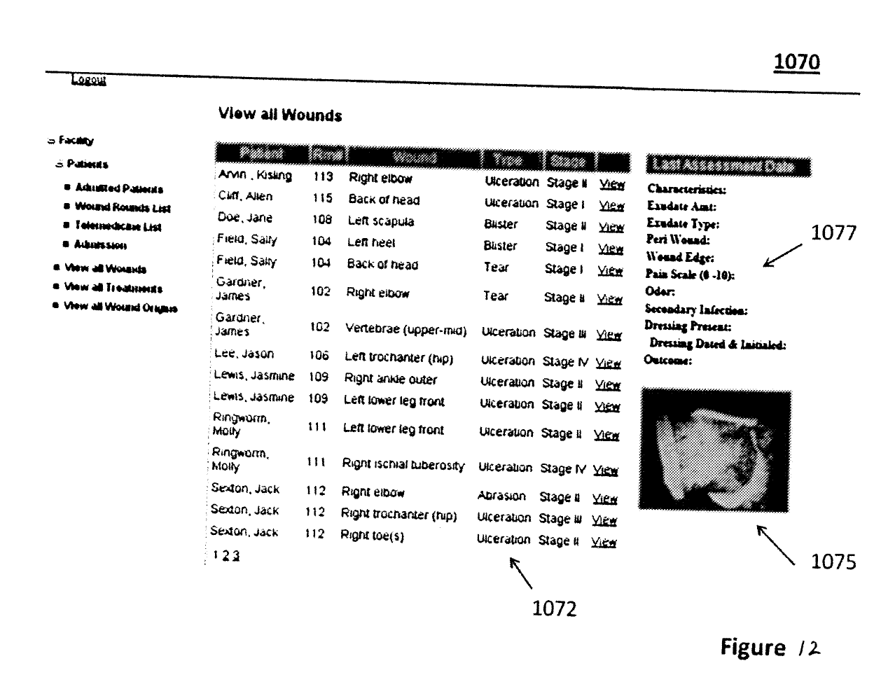

As illustrated in FIG. 12, selection of a View hyperlink will display a picture 1075 of the selected wound, along with a chart 1077 of the Last Assessment Data for that wound. The Last Assessment Data chart 1077 provides wound information including characteristics, exudate, odor, secondary infection, width, length, depth and outcome.

Referring now to FIG. 13, the Facility—View all Treatments screen 1090 is illustrated. Screen 1090 displays a list of patients, their wounds, and their treatments in patient treatment information display field 1092. Patient treatment information display field 1092 includes the patient's name, room number, wound site and treatment.

Referring now to FIG. 14, the Facility—View all Wound Origins screen 1100 is illustrated. Screen 1100 displays a list of patients, their wounds, and their wound origin in patient wound origin information display field 1102. Patient wound origin information display field 1102 includes the patient's name, room number, wound site, wound type and the place where the wound originated. This list may be continued on an additional page or pages.

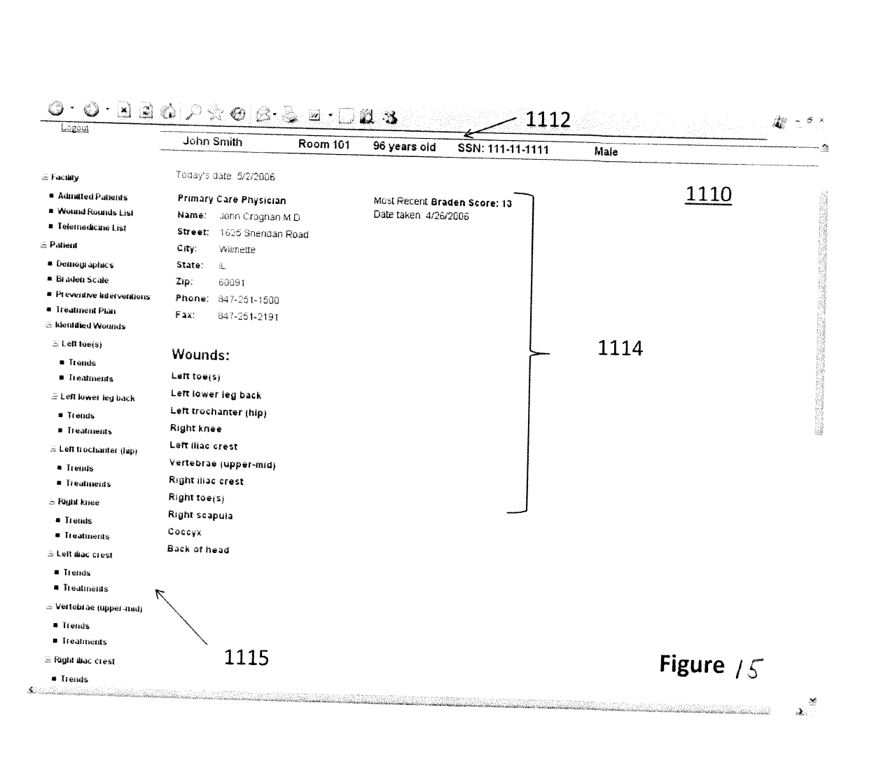

FIGS. 15-26 illustrate information in the disclosed method and system regarding an exemplary patient case, providing detailed information to the user about the patient, the patient's wound or wounds, and the management and/or treatment of the patient's wound or wounds, all of which will provide the highest quality wound care and management, and will lead to improved wound healing, prevention of additional skin breakdown, prevention of decline in overall condition and reduction of pain, while being specialized to each patient.

Accordingly, FIG. 15 is an exemplary server side Patient Information screen 1110 of a preferred embodiment of the method and system of the present disclosure. This screen 1110 is accessed when a patient is selected for example from one of the patients lists illustrated in FIGS. 7-14. Screen 1110 of FIG. 15 provides general information about the selected patient in a patient header line 1112, including the patient's name, room number, age, social security number and gender. This patient header line 1112 will be displayed on each of the patient case screens of FIGS. 15-21. The Screen 1110 also displays summarized patient information 1114, including the patient's PCP, the patient's most recent Braden scale score and the date taken, and the location of each of the patient's wounds. Screen 1110 further includes a menu 1115 having menu options for Patient Demographics, Patient Braden Scale information, Patient Preventive Interventions, and the Trends and Treatments for each of the patient's Identified Wounds site.

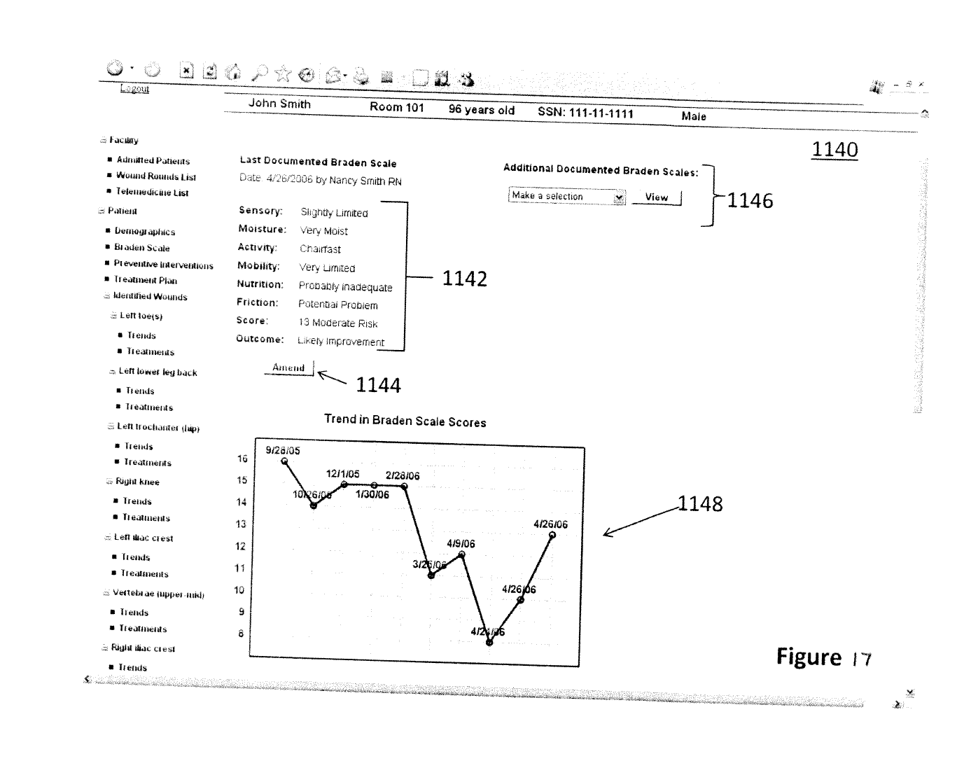

Selection of the menu item Braden Scale under the Patient heading in menu 1115 of FIG. 15 will display the Patient Braden Scale screen 1140 of FIG. 17. In addition to patient header line, this Screen 1140 displays patient Braden Scale information 1142 including the date and by whom the Last Documented Braden Scale analysis was made, and the relevant information for that Braden Scale analysis, including sub-category scores for sensory, moisture, activity, mobility, nutrition, and friction, as well as the overall Braden score and anticipated outcome information. An Amend button 1144 is provided to allow this information to be amended when a new Braden Scale analysis is desired.

Screen 1140 also includes a Trends in Braden Scale Scores chart 1148, which charts all of the patient's Braden Scale analyses by date and score. Chart 1148 provides the user with a graphical depiction of how the patient's level of risk is progressing or regressing as the case may be. This chart can be a valuable tool to assist the user in formulating preventive intervention plans for the patient or changes to the patient's preventive intervention plan.

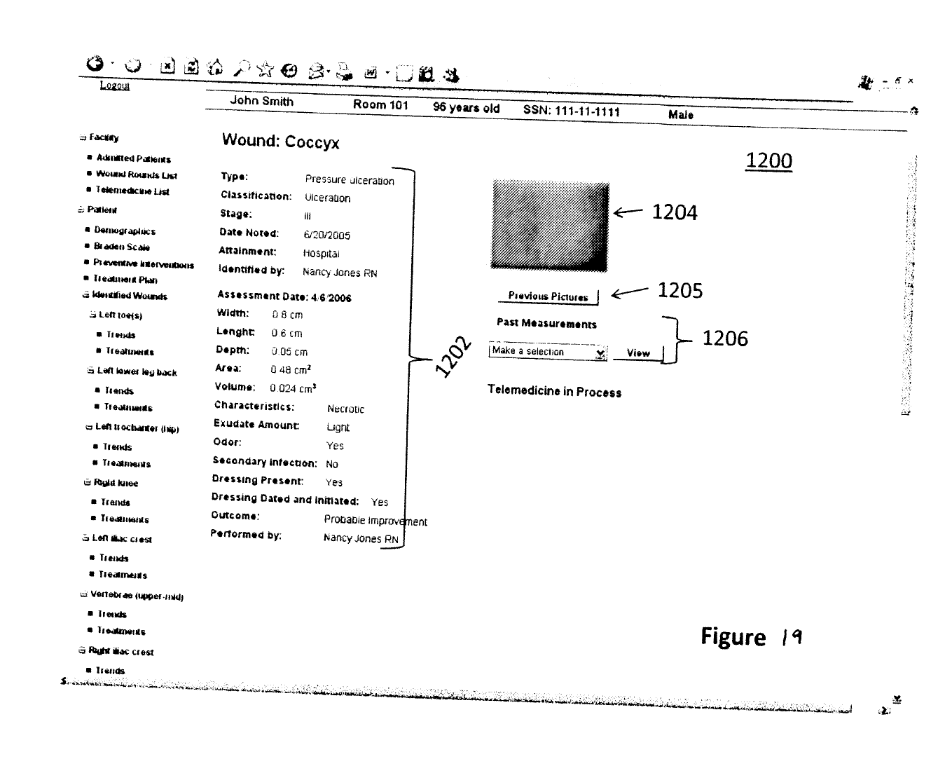

Referring now to FIGS. 19-24, detailed information regarding the identified wounds of the patient is provided. Selection of a specific wound listed under the menu item Identified Wounds in menu 1115 will display the Patient Identified Wounds screen 1200 of FIG. 19, as illustrated by way of example for the selected wound site Coccyx. In addition to the patient header line, this Screen 1200 displays the latest wound assessment information 1202 entered for the selected wound, including wound type, classification, stage, date noted, attainment location, person who identified the wound, assessment date, width, length, depth, area, volume, characteristics, exudate amount, presence of odor, presence of secondary infection, presence of dressing, whether the dressing is dated and initiated, outcome, and the person making the assessment.

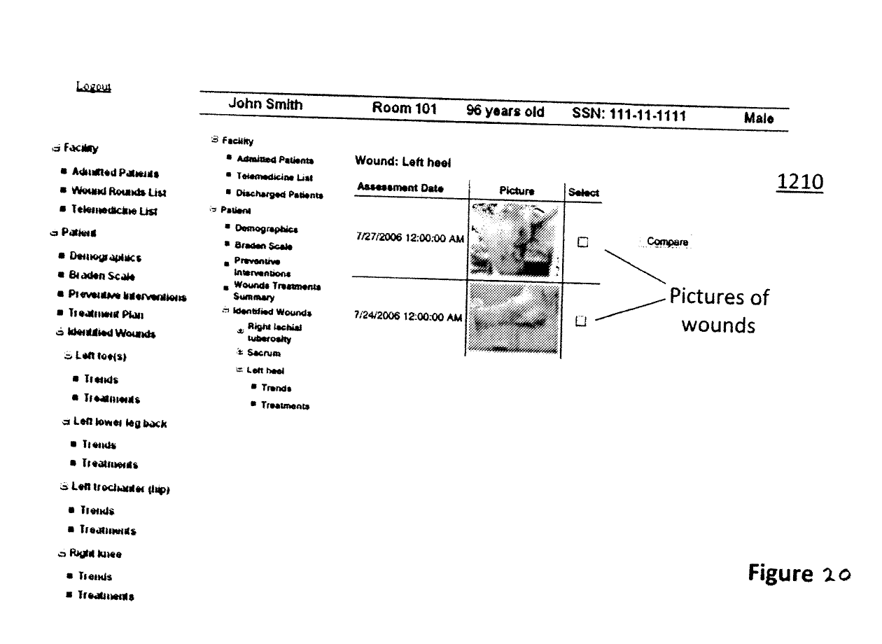

Additionally on Screen 1200 of FIG. 19, a picture 1204 of the wound at the time of the latest assessment is displayed, along with a Previous Pictures button 1205, allowing the user to access all of the pictures of the wound to date. Upon selection of button 1205, all of the pictures of the wound are displayed in chronological order as illustrated in the Patient Identified Wounds Pictures screen 1210 of FIG. 20. Here, the user can select two or more of these pictures for a more detailed comparison, using the select boxes next to each picture and the Compare button.

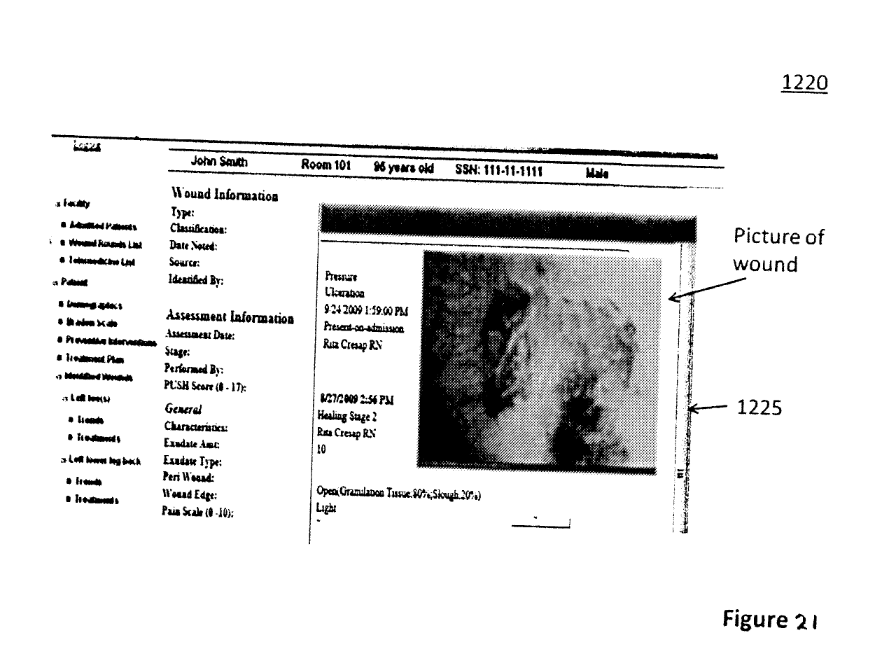

Also on Screen 1200 of FIG. 19, a Past Measurements selection field 1206 is provided, allowing the user to access all of the past wound assessments for the wound. Upon selecting a past assessment from the drop down menu and clicking the View button, a pop-up window 1225 is displayed as illustrated in the Patient Past Wound Assessment screen 1220 of FIG. 21. Here, the user can view the selected past assessment data and picture for the wound for the selected assessment.

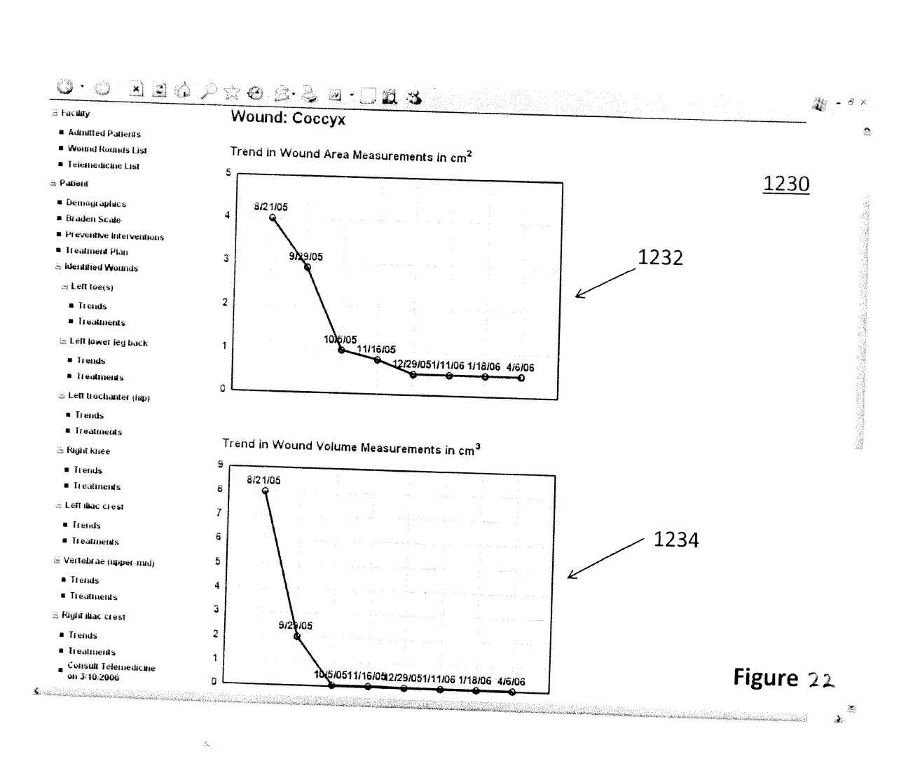

Selection of the menu item Trends under the listed wound in menu 1115 will display the Patient Identified Wounds Trends screen 1230 of FIG. 22. In addition to the patient header line, this Screen 1230 displays one or more charts of the patient's wound assessment information by date and assessment category (measurements, etc.). As shown in Screen 1230, a first Chart 1232 provides the user with a graphical depiction of how the wound is progressing or regressing, as the case may be, with respect to the measured area of the wound over time. A second Chart 1234 provides the user with a graphical depiction of how the wound is progressing or regressing, as the case may be, with respect to the measured volume of the wound over time. Other charts of the wound information 1202 are contemplated. These charts can be a valuable tool to assist the user in formulating treatment plans for the patient or changes to the patient's treatment plan.

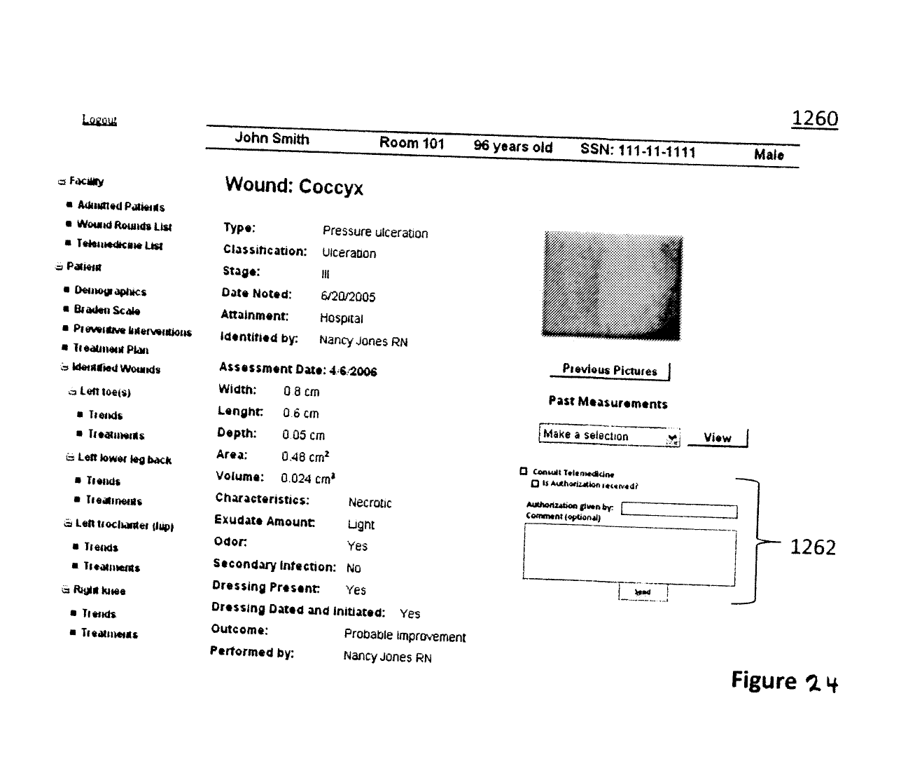

Preferably, the Patient Identified Wounds screen 1200 of FIG. 19 may also include a Consult Telemedicine section 1262, as illustrated in Patient Consult Telemedicine Authorization screen 1260 of FIG. 24. This section 1262 includes a Consult Telemedicine check box to initiate the Telemedicine consultation feature of the system. Section 1262 also includes a check box for the question—Is Authorization received? An Authorization Given By entry field is provided where the appropriate user can select the name of the person giving authorization. An optional Comment entry box is also provided. A Send button is then selected to submit authorization for Telemedicine consultation. Once authorized, the request for Telemedicine consultation along with any entered comments will be sent to the appropriate consultant, and can be accessed from screen 1040 of FIG. 9.

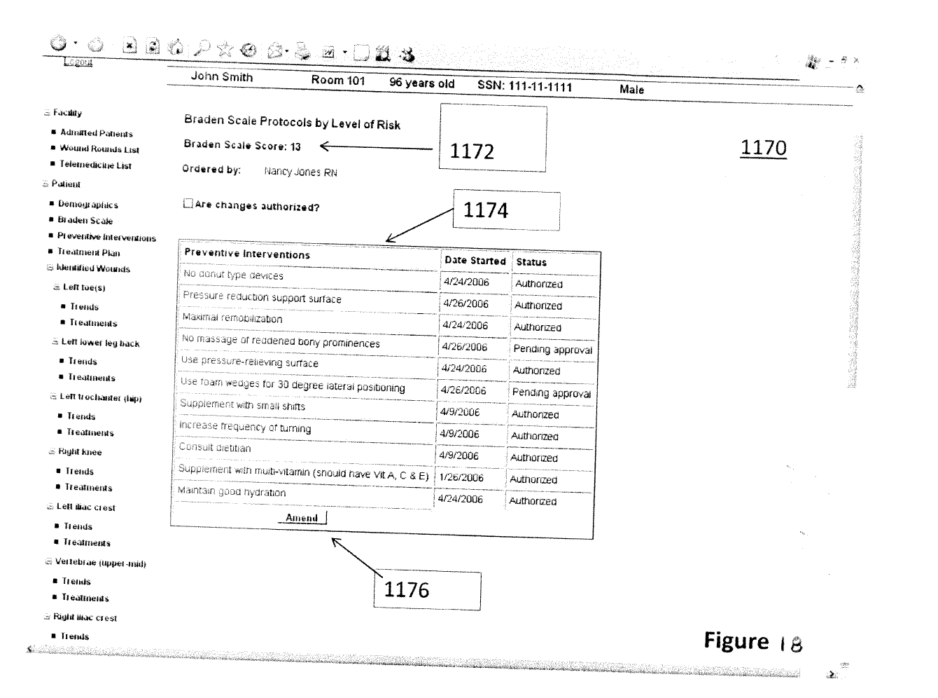

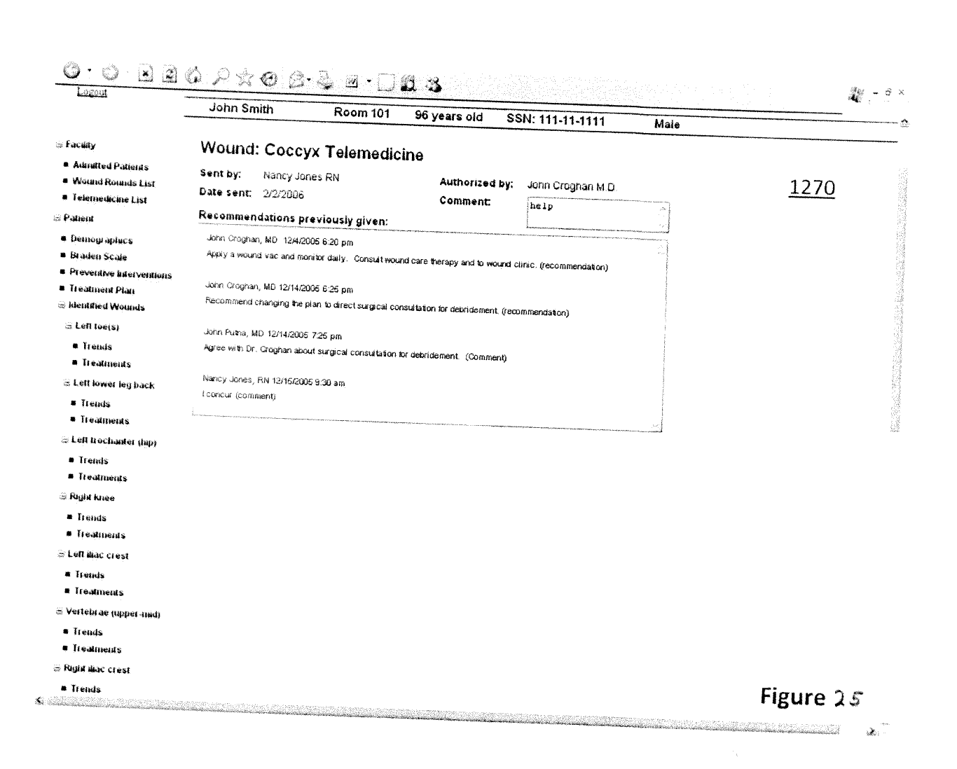

While not shown, it should be understood that selection from menu 1295 of the menu item Preventive Interventions and the menu items under Identified Wounds will display respective screens providing detailed information about the patient and/or the patient's wounds, the same or similar to the information illustrated in FIGS. 18-24, as well as FIG. 25 when and if the menu 1295 includes a Consult Telemedicine menu item.

Accordingly, it should be understood from the foregoing that the method and system of the present disclosure provides a clinical documentation and care management protocol wherein a registered nurse or designated healthcare provider at a hospital, nursing home, home care, or other location will, for example, make routine wound rounds on patients with pressure ulcers. The healthcare provider will use the customized, wireless device 20 with the above described software application to record clinical data regarding both the patient and the wound, along with a digital photo of the wound. This information will be uploaded, via the internet into a password-protected website/server/database 30. The website/server/database 30 and the wireless devices 20 utilize the software application to help generate accurate assessment documentation and guide treatment planning. A healthcare supervisor or administrator can oversee, for quality assurance purposes, the prevalence and treatment of pressure ulcers/wounds.

The disclosed method and system provides a comprehensive system for the prevention, management and treatment of wounds. The primary clinical outcome measures will be wound prevention, change in wound condition over time and time to heal. These outcomes will be analyzed for the overall sample as well as stratified samples, such as baseline Braden score or recent illness. Further, the present invention will aid greatly in organizing the epidemiologic data collected uniformly to be reported uniformly in elderly patients with pressure ulcers. Preferably, the system will collect and compile data and/or statistics on all of the patients' information and wound information, and selectively provide information regarding any aspect of the same, for example percentage of male patients with a wound at a particular site receiving a specific treatment. This information will be used by the healthcare provider to improve treatment plans for a given patient. It is also foreseen that the system may incorporate clinical algorithms to recommend changes and/or enhancements to the user-defined preventive intervention plan or treatment plans accordingly.

It is to be understood that the embodiment(s) herein described is/are merely illustrative of the principles of the present invention. Various modifications may be made by those skilled in the art without departing from the spirit or scope of the claims which follow.

What is claimed is:

1. A method for improving the prevention, management and/or treatment of wounds, comprising the steps of:
storing information in a database of a computer hardware, software and display system, wherein the information about the patient includes patient demographic information and patient Braden Scale information;
determining a Braden Scale score for the patient based upon the patient Braden Scale information; and
providing a display of one of a plurality of predetermined preventive intervention plans for the patient based upon at least the Braden Scale score and the patient demographic information.

2. The method of claim 1, further comprising the step of displaying output comprising an image of a selected wound and the last assessment data for said wound.

3. The method of claim 2, wherein the last assessment data for the wound includes wound information, characteristics, exudate, odor, secondary infection, width, length, depth and outcome.

4. The method of claim 1, further comprising the step of displaying output comprising a patient's identified wound, an image of the identified wound at the time of the latest assessment, a button allowing the user to view all images of the identified wound to date, and a button allowing the user to view all of the past wound assessments for said identified would.

5. The method of claim 4, wherein the patient's identified wound includes the patient header line and the patient's latest wound assessment information for the selected identified wound.

6. The method of claim 5, wherein the patient header line includes the patient's name, room number, age, social security number and gender.

7. The method of claim 5, wherein the latest wound assessment information includes the wound type, classification, stage, date noted, attainment location, person's name who identified the wound, assessment date, width, length, depth, area, volume, characteristics, exudate amount, presence of odor, presence of secondary infection, presence of dressing, presence of dressing date and initiation, outcome and person's name making the assessment.

8. The method of claim 4, wherein selection of the button to view all images of the wound to date further comprises the step of displaying all the images of the wound in chronological order.

9. The method of claim 8, wherein the user can select at least two images and obtain a detailed comparison of the at least two images.

10. The method of claim 4, wherein selecting the button to view all past wound assessments further comprises the step of displaying selected past assessment data and images for the wound for said selected assessment.

11. The method of claim 1, further comprising the step of displaying a consulting option.

12. The method of claim 11, wherein the consulting option includes an authorization given by field, an optional comment field and a send button.

13. The method of claim 12, wherein the send button sends the request for the consulting option and any entered comments.

14. The method of claim 1, further comprising the step of displaying a graphical depiction of a patient's Braden Scale scores over time.

15. The method of claim 1, further comprising the step of displaying a graphical depiction of a patient's wound area measurements over time.

16. The method of claim 1, further comprising the step of displaying a graphical depiction of a patient's wound volume measurements over time.

17. A system for the prevention, management and/or treatment of wounds, comprising:
an electronic device comprising a computer hardware, software and display device for entering information about a patient in a database, wherein the information about the patient includes patient demographic information and patient Braden scale information;
said computer hardware including a storage device for receiving and storing information from the electronic device; and
a software application associated with the electronic device and the storage device for determining a Braden Scale score for the patient based on the patient's Braden scale information, and for providing a display of one of a plurality of predetermined preventive intervention plans for the patient based upon at least the Braden Scale score and the patient demographic information.

18. The system of claim 17, wherein the software application provides for the display of an image of a selected wound and the last assessment data for said wound, via the electronic device.

19. The system of claim 18, wherein the last assessment data includes wound information, including wound characteristics, exudate, odor, secondary infection, width, length, depth and outcome.

20. The system of claim 17, wherein the software application displays the patient's identified wound, an image of the identified wound at the time of the latest assessment, a button allowing the user to view all pictures of the identified wound to date and a button allowing the user to view all of the past wound assessments for said identified wound, via the electronic device.

21. The system of claim 20, wherein the patient's identified wound includes the patient header line and the patient's latest wound assessment information for the selected identified wound.

22. The system of claim 21, wherein the patient header line includes the patient's name, room number, age, social security number and gender.

23. The system of claim 21, wherein the latest wound assessment information includes wound type, classification, stage, data noted, attainment location, person's name who identified the wound, assessment date, width, length, depth, area, volume, characteristics, exudate amount, presence of odor, presence of secondary infection, presence of dressing, presence of dressing dated and initiated, outcome and the person's name making the assessment.

24. The system of claim 20, wherein the selection of the button to view all images of the wound to date further comprises the step of displaying all the images of the wound in chronological order via the electronic device.

25. The system of claim 24, wherein the user can select at least two images and obtain a detailed comparison via the electronic device.

26. The system of claim 20, wherein selection of the button to view all of the past wound assessments further comprises the step of displaying selected past assessment data and images for the wound for the selected assessment via the electronic device.

27. The system of claim 17, wherein the software application provides for a display of a consulting option, via the electronic device.

28. The system of claim 27, wherein the consulting option includes an authorization given by field, an optional comment field and a send button.

29. The system of claim 28, wherein the send button sends the request for the consulting option and any entered comments.
